(19) United States
(12) Patent Application Publication
(10) Pub. No.: US 2008/0228930 A1
(43) Pub. Date: Sep. 18, 2008

(54) METHOD, APPARATUS, AND PROGRAM PRODUCT FOR PROVIDING WEB SERVICE

(75) Inventor: Michiaki Tatsubori, Kanagawa-ken (JP)

Correspondence Address: FREDERICK W. GIBB, III;Gibb & Rahman, LLC, 2568-A RIVA ROAD, SUITE 304, ANNAPOLIS, MD, 21401, US

(73) Assignee: INTERNATIONAL BUSINESS MACHINES CORPORATION, ARMONK, NY (US)

(21) Appl. No.: 12/060,429

(22) Filed: Apr. 1, 2008

Related U.S. Application Data
(63) Continuation of application No. 11/427,817, filed on Jun. 30, 2006.

(30) Foreign Application Priority Data
Jul. 19, 2005 (JP) 2005-208184

(51) Int. Cl. G06F 15/16

(52) U.S. Cl. 709/228

(57) ABSTRACT

A simple method for providing an existing Web application as a Web service is desired that can be applied to a Web application maintaining user sessions across a plurality of pages and that is simple for a conversion proxy and a Web service client.

### CROSS-REFERENCE TO RELATED APPLICATIONS

This application is a Continuation of U.S. application Ser. No. 11/427,817 filed Jun. 30, 2006, the complete disclosure of which, in its entirety, is herein incorporated by reference.

### DETAILED DESCRIPTION OF THE INVENTION

1. Field of the Invention

The present invention relates to a method, apparatus, and program product for providing a Web service. More specifically, the present invention relates to a method, proxy apparatus, and control program product thereof for providing a Web application as a Web service.

2. Background Art

In these years, methods for providing Web applications as Web services (conversion to Web service) are known. A Web application is application software on a Web server accessed by a user such as via a Web browser, and is constructed mainly with techniques centering on interfaces between the user and the application on the Web server. On the other hand, a Web service is a technique centering on inter-system interfaces that allow one information system to use another information system via a network, or a Web service means an aggregate of software created and deployed using such techniques.

It is useful for Web service providers as well as Web application developers and users if existing Web applications can be used as Web services between systems. For example, when both a Web application and a Web service are provided, it is often the case that a common web application is intensively developed before the Web service is provided. This is done for the purpose of reducing the development cost by rapidly developing the essential Web application and then providing the Web service for such a reason as a heavy demand for the application. For an application development that uses a third party-provided Web application, using the third-party Web application as a Web service advantageously allows utilization of rich know-how and environment for the Web service development.

Therefore, techniques are known for converting a Web application into a Web service without changing the Web application (for example, Patent Documents 1 and 2).

[Patent Document 1] Published Unexamined Patent Application No. 2005-149131

[Patent Document 2] Published Unexamined Patent Application No. 2005-56058

### DISCLOSURE OF THE INVENTION

### Problems to be Solved by the Invention

However, conventional techniques are only directed to a single user session in a Web application and cannot be applied to a Web application maintaining user sessions across a plurality of Web pages, i.e., a so-called “stateful” Web application. That is, these techniques assume that a user session is reestablished for each Web page switching. For example, the Patent Document 1 discloses protocol analysis and conversion methods between a Web application and a Web service, but does not describe user session management.

The Patent Document 2 is an example applicable to stateful Web applications. However, it requires managing a session state on a proxy server, making the session management complicated between the proxy server and a Web service client. It also requires configuring the proxy server by explicitly specifying how session information is passed, thereby requiring configuration effort. Moreover, since the session information is passed from the proxy server to the Web service client via the Web service's transmission layer (HTTP), a Web service client adaptable to a special transmission layer is required.

Accordingly, what is desirable is a simple method that does not impose significant burdens on a proxy server converting a Web application into a Web service and that can configure a flexible Web service client requiring no complicated programming or special middleware on the client that requests services.

An object of the present invention is to provide a method that solves the above problems and enables configuration of a simple and flexible Web service client for a stateful Web application.

### SUMMARY OF THE INVENTION

The present invention proposes a method for providing a Web service in which a proxy apparatus accesses a Web application server in response to a request from a Web service client, the method comprising the steps of: transmitting an HTTP request to the application server in response to a request from the Web service client; embedding, into a response to the Web service client, user session information extracted from an entity header and an entity body in an HTTP response returned from the Web application server in addition to application information extracted from the entity body in the HTTP response; and embedding the user session information contained in a request from the Web service client into an entity header and an entity body as part of application data in an HTTP request and transmitting the HTTP request to the Web application server.

According to the above invention, a proxy apparatus issues an HTTP request to an HTTP server storing a Web application in response to a request from a Web service client. When the proxy apparatus receives an HTTP response thereto from the HTTP server, the proxy apparatus extracts user session information from the HTTP response and embeds the user session information into a response to the Web service client. The Web service client may embed the user session information into subsequent requests as part of application data and transmit the requests in such a manner that the user session information is distinguishable from other application data. The proxy apparatus embeds the user session information contained in a request received from the Web service client into an HTTP request and transmits the HTTP request to the HTTP server, thereby allowing the original user session to be resumed. Thus, the Web service conversion can be implemented in a simple manner without burdening either the Web service client or the proxy apparatus with user session management.

### ADVANTAGES OF THE INVENTION

The present invention allows an existing stateful Web application to be converted into a Web service without complicated programming. In addition, having the Web service conversion of the present invention applied, a plurality of operations corresponding to a plurality of HTTP sessions can be combined in a language such as BPEL4WS (Business Process Execution Language for Web Service) to provide them as a single service. That is, a series of operations of a Web application across a plurality of HTTP sessions can be provided as a single service in a simple manner.

### PREFERRED EMBODIMENT

Now, the present invention will be described through its embodiments. The embodiments below are not intended to limit the present invention set forth in the claims. Furthermore, not all the combinations of components described in the embodiments are essential to solutions by the present invention.

FIG. 1 shows an overview of a system configuration for providing a Web service according to the present invention. A Web service client 30 requesting provision of a Web service communicates with a proxy apparatus 10 via the Internet 20. The proxy apparatus 10 communicates via a communication path 50 with a Web application server 40 providing a Web application. The communication path 50 may be a local area network (LAN). Thus, the proxy apparatus 10 acts as an intermediary between the Web service client 30 and the Web application server 40. A communication protocol typically used between the proxy apparatus 10 and the Web service client 30 is SOAP (Simple Object Access Protocol), although other protocols, for example CORBA (Common Object Request Broker Architecture), are also applicable. Used between the Web application server 40 and the proxy apparatus 10 is a general HTTP protocol. While the embodiments below are described with HTTP as an exemplary protocol for the Web application server, the basic configuration will be similar with other protocols.

The proxy apparatus 10 includes a SOAP request receiver 11b, a request parser 11a, a response generator 14a, and a SOAP response transmitter 14b for processing SOAP requests from and responses to the Web service client 30. The proxy apparatus 10 further includes an HTTP request generator 12a, an HTTP request transmitter 12b, an HTTP response receiver 13b, and an HTTP response parser 13a for processing requests to and responses from the Web application server 40. A controller 15 that controls the overall operation is also included. The request parser 11a receives a request for a Web service from the Web service client via the SOAP request receiver 11b and parses the message content.

Based on the SOAP request, the HTTP request generator 12a transmits an HTTP request to the Web application server 40 via the HTTP request transmitter 12b.

The HTTP response parser 13a extracts information required for session management embedded in an HTTP response to the HTTP request from the Web application server. Details about the extraction will be described below.

The response generator 14a embeds, under the control of the controller 15, the information required for session management extracted by the HTTP response parser 13a into the SOAP body of a SOAP response to the Web service client. The Web service client, receiving the SOAP response containing the user session information, will embed this user session information as is into subsequent SOAP requests. The user session information will also be embedded by the HTTP request generator 12a into subsequent HTTP requests.

FIG. 4 shows the above-described transmission and reception process. In the following description, the proxy apparatus 10, the Web service client 30, and the Web application server 40 in FIG. 1 are referred to as a conversion proxy 64, a WS client 63, and a Web application 62, respectively. For comparison, FIG. 2 shows a transmission and reception process between a stateless Web application (i.e., one reestablishing a user session for each Web page switching) and a user via a Web browser 61. As shown, each user input or click causes an HTTP request (S02, S06) to be issued to the Web application. According to HTTP responses (S03, S07) to the HTTP requests, the Web browser 61 displays a form, result, and so on.

FIG. 3 shows a transmission and reception process between the WS client 63 and the Web application 62 via the conversion proxy that converts such a stateless Web application into a Web service by using a conventional technique. In the process of FIG. 3, an HTTP request S12 is issued for a SOAP request S11. However, the user session information is never extracted from an HTTP response S13, nor embedded into a SOAP response S14. On the other hand, in the process shown in FIG. 4, an HTTP request S22 is issued for an initial SOAP request S21. Then, an HTTP response S23 to the HTTP request S22 is returned from the Web application server. From the HTTP response S23, the user session information is parsed and (automatically) extracted.

The user session information, embedded into a SOAP request S25, is (automatically) embedded into an HTTP request S26 (in an appropriate manner). Thus, as the user session information returned in S24 is embedded and transmitted in S25, transmission and reception of S26-S27 can continue the session of S22-S23. The user session information is again (automatically) extracted from an HTTP response S27 and embedded and transmitted in S28. Thereafter, in a similar manner, the returned user session information is embedded into a SOAP request, so that the corresponding HTTP transmission and reception can continue the original HTTP transmission and reception session. This eliminates the necessity of reestablishing a user session for each SOAP request and allows the previous user session to be resumed.

The functionality of the WS client 63 (see FIG. 4) is typically implemented by a program, such as BPEL4WS, configured on a workflow engine, or by software written in a general programming language such as Java (R). FIG. 5 shows an example of its transmission and reception process. A workflow engine 65 may use the session management information returned (S34) from a Web service port provided by the conversion proxy 64 and transmit it as is (S35) to another Web service port provided by the Web service conversion proxy.

FIG. 6 shows message structures of HTTP requests and responses, used for explaining operations of the conversion proxy according to the present invention. In the conversion proxy according to the present invention, as described above, the session information contained in an HTTP response 72 transmitted from the HTTP server is extracted and treated as user session information to be returned from the HTTP server. This information is embedded into a response to the HTTP client as application data in an Entity-Body 73 in the form of a distinguishable series of information.

Embedding the user session information into the Entity-Body as application data simplifies session information management between the conversion proxy and the Web service client. That is, the session management information is not transferred between the Web service client and the conversion proxy as metadata such as a Cookie header of HTTP, which is a transport layer of SOAP, or a SOAP header. The Web service client needs to be aware of the existence of the session information, but not of its content. The Web service client may simply include the session information obtained from the first Web service response in a series of messages of a session directly into the next Web service request. This allows configuration of a flexible Web service client, such as one sharing the obtained session information among several client applications.

The following three items are extracted as the session information.

1) Set-Cookie header information, and the value of Cookie that is set when a SCRIPT element in the Entity-Body is emulated.
2) the URI of an “action” attribute value specified in a FORM element in the Entity-Body, or the target URI of a regular hyperlink (in the following description, a regular hyperlink is assumed to take a special form such that it is a GET method without an INPUT control).
3) pairs of “name” and “value” attribute values of INPUT controls in the FORM in which a “type” attribute is set to “hidden.”

The conversion proxy embeds the extracted user session information into the SOAP body of the SOAP response to allow the Web service client to embed and transmit this user session information as is in subsequent Web service requests. The conversion proxy also embeds the received user session information into the HTTP request 73 by using an appropriate session management technique and transmits the request to the HTTP server.

### <Data Structures>

For comparison, FIG. 7 shows data structures of a SOAP request 100 and a SOAP response 110 in a conventional Web service conversion, and of a SOAP request and response in the Web service conversion according to the present invention. Basically, it may be considered that session information 104 is simply added to a SOAP body 101. In these structures, the session information is always embedded in the SOAP body 101 of the SOAP request 100 as application data.

Therefore, the session information need not to have its content checked by the conversion proxy and may be embedded into an HTTP request as is.

FIG. 8 shows a structure of a session information section. Among these elements, “action” (zero or one) contains the value of an “action” attribute of a Form tag, “Cookie” (zero or one) contains the value of “Cookie” that is set by a Set-Cookie header, Cookie header, or script, and “hidden” (zero or more) contains a pair of “name” and “value” that are set at an INPUT control having a “hidden” attribute.

By using the above-described technique, all the settings of information for session management are automatically performed by the conversion proxy, and the existence of session management by a URI need not be explicitly specified by the user (Web service client). Moreover, session management by rewriting an “action” attribute value in the Form, and session management by rewriting a hidden field in the Form may be accommodated.

### <Algorithm>

FIG. 9 shows an overview of a Web service conversion algorithm carried out by the Web service conversion proxy according to the present invention. First, when a SOAP request is received (step S100), the request parser 11a (see FIG. 1) deserializes and parses the SOAP message (step S101).

The HTTP request generator 12a (see FIG. 1) then generates an HTTP request for the SOAP request (step S102). If there is an “action” element in the SOAP message, the Request-URI is modified according to the element value (step S103). If there is a “Cookie” element, the “Cookie” element value is used to add a Cookie header to the Entity-Header (step S104). If there is a “hidden” element, a pair of “name” and “value” attribute values is added to the Request-URI in the case of a GET method, or to the Entity-Body in the case of a POST method (step S105). Then, the HTTP request is transmitted (step S106).

The HTTP response parser 13a (see FIG. 1) receives a response to the transmitted HTTP request (step S107) and parses its content (step S108). If the status code is “3XX” indicating redirect (step S109: Yes), a redirect HTTP request is transmitted (step S111). If the status code is “200” indicating a normal status (step S110: Yes), the processing is passed to the response generator 14a (see FIG. 1).

The response generator 14a generates a SOAP response (step S113) and adds session information (sessionInfo section) to the generated SOAP response (step S114). Then, the HTML is parsed and emulated for adding information about the application section itself (step S115). Furthermore, processing for a handle Entity-Header (step S116), a handle HTML Script (step S117), and a handle HTML Form (step S118) is performed respectively (described below). Finally, the SOAP response is transmitted (step S119) and the processing terminates.

FIG. 10 shows details of generation of the HTTP request (step S102) First, the HTTP Request-Line is set (step S102a) according to the settings of an adapter configuration (described below), and the HTTP Entity-Header is set along with a header such as a User-Agent (step S102b). The HTTP Entity-Body is set to void (step S102c). A pair of “name” and “value” attribute values is extracted from the application section (part that is not “sessionInfo”) (step S102d). The pair of “name” and “value” attribute values is added to the Request-URI in the case of a GET method (step S102f), or to the Entity-Body in the case of a POST method (step S102g).

FIGS. 11 to 13 show the processing for each of the handles “action,” “cookie,” and “hidden” (S103, S104, and S105), description of which is omitted here since it is already apparent from the description of FIG. 9.

FIGS. 14 to 16 show details of an algorithm for generating the Web service response from the received HTTP response. For a handle Entity-Header (step S116), if there is a Set-Cookie header in the Entity-Header (step S116a: Yes), a “cookie” element is added according to the header (step S116b). For a handle HTML Script (step S117), if there is a “cookie” that has been set by the Script (step S117a: Yes), a “cookie” element is added according to the result of emulating the Script (step S117b). For a handle HTML Form (step S118), an “action” element is added according to an “action” attribute value in the HTML Form (step S118a). Then, if there is a “hidden input” (step S118b: Yes), a “hidden” element is added according to the “hidden input” (step S118c).

### <Setting>

The Web service conversion proxy according to the present invention is provided with setting information (adapter configuration) as shown in FIG. 17. An “HTTP Server to adapt” part 500 provides an HTTP server's host name or IP address, as well as TCP port. A “WSDL setting” part 501 specifies a namespace and name of a WSDL (Web Service Description Language) to be generated. WSDL is an XML grammar for describing the content of a Web service and is referred to by the Web service client.

Although one HTML page may contain a plurality of forms (FORM elements), the following description assumes that, for simplicity, one HTML page contains only one form. To allow a plurality of forms, each form is associated with one Web service operation.

A “Flag for State-aware” part 502 specifies whether a stateful Web application is allowed or not. If it is set to false, a Web service conversion is performed that allows only a conventional stateless Web application. If it is set to true, a Web service conversion is performed that allows a stateful Web application according to the present invention.

For each HTTP session (pair of an HTTP request and response), an “HTTP Request Method” part 503, a “WSDL operation name” part 504, a “Request setting” part 505, and a “Response setting” part 506 are set. Among these parts, the “HTTP Request Method” part 503 specifies GET or POST, and the “WSDL operation name” part 504 specifies the name of a corresponding WSDL operation.

The “Request setting” part 505 specifies which part of information originally entered by a user is adapted to be received as a Web service request and which part is to be fixed. The “Response setting” part 506 specifies which part of the HTML content returned from the server is to be returned as a Web service response.

Detailed description about how to retrieve which part of the HTML is omitted here, as it is relevant to existing techniques such as one introduced in [“A Brief Survey of Web Data Extraction Tools,” Alberto H. F. Laender and Berthier A. Ribeiro-Neto, ACM SIGMOD Record, Volume 31, Issue 2, June 2002]. Any existing techniques are applicable. For example, one may describe that a part of the HTML specified by a certain XPath should be converted into a String type of XML (eXtensible Markup Language) schema and enclosed with a specified element.

### <Generating WSDL>

Based on the above-described setting information, and in some cases on additional user-specified settings such as mappings of naming, a WSDL for a service provided by the Web service conversion is generated. Basically, information specified in the “Request setting” part 505 is mapped to a Message Part in a Web service request, and information specified in the “Response setting” part 506 is mapped to a Message Part in a Web service response. Furthermore, regardless of the setting information, messages in the event of errors are appropriately defined. Such processing is common to tools for performing a Web service conversion of Web applications in general.

The upper part of FIG. 18 shows such a typical WSDL Generator. However, as in the lower part of FIG. 18, the technique according to the present invention refers to a stateful-awareness flag (510) and adds to the WSDL a part that is necessary for conveying session information (520). The technique according to the present invention automatically defines the Message Part for conveying the session information and adds it to the WSDL description. Specifically, a WSDL is generated that has data with a structure shown in FIG. 6 as part of its regular Message Part or as a separate Message Part.

FIG. 19 shows this algorithm. First, a WSDL description is generated according to given setting information (regular process) (step S541). Then, a statefulness-aware option (corresponding to 502 in FIG. 17) is read (step S542). If the statefulness-aware option is true (step S543: True), the session information (sessionInfo section) is added to each message in the WSDL description (step S544).

This is described below with reference to a specific example.

### <Example of Generating WSDL>

Assume that setting information as shown in FIG. 20 is given. From this setting information, a WSDL as shown in FIG. 21 is generated.

Here, the session information is a separate Message Part (SessionInfo section), and information about the main form input and result is another Message Part (RequestDocument/ResponseDocument sections). Alternatively, one part may include the content of a session information element (html2ws:sessionInfo) and a form input element (app:searchRequestelement), and another part may include the content of a session information element (html2ws:sessionInfo) and a result element (app:searchResponseElement), so that these parts may be the content of searchRequest and searchResponse messages, respectively. Although the latter form is essentially a more typical Web service and easier to deal with, the former approach is used in the illustration here for the sake of clarity of appearances of the session information elements.

Among messages created according to the WSDL of FIG. 21 and transmitted from the Web service client, one that corresponds to a WSDL operation “search” is as shown in FIG. 22.

Here, the proxy according to the present invention has converted a SOAP request of [Formula 1] into an HTTP request of [Formula 2], and an HTTP response of [Formula 3] into a SOAP request of [Formula 4].

```
[Formula 1]
<s:Envelope
xmlns:ss=“http://schemas.xmlsoap.org/soap/envelope/”>
<s:Body>
<html2ws:sessionInfo xmlns:html2ws=“uri:html2ws.xsd”>
<html2ws:action>/order/Submit.jsp;jsessionid=OqXn3Ab9</html2ws:
action>
<html2ws:cookie>ahfodada:adfaxlkjdfa:OqXn3Ab9</html2ws:cookie>
      <html2ws:hidden name=“id”>OqXn3Ab9<html2ws:hidden>
    </html2ws:sessionInfo>
    <m:searchRequestElement xmlns:m=“uri:app.xsd”>
      <m:query>Britney Spears</m:query>
    </m:searchRequestElement>
  </s:Body>
</s:Envelope>
[Formula 2]
POST/order/Submit.jsp;session=OqXnb9 HTTP/1.1
Host: scholar.google.com
User-Agent: Mozilla/5.x
Cookie: ahfodada:adfaxlkjdfa:OqXn3Ab9
q=Britney Spears;id=OqXn3Ab9
[Formula 3]
HTTP/1.1 200 OK
Date: Fri, 22 Oct 2004 20:59:30 GMT
Set-Cookie: ahfodada:adfaxlkjdfa:OqXnb9
Content-Type: text/html
Content-Length: 1234
<html>
<form action=“/scholar;sesson=EF01234567” ..>
<input .. name=“q” value=“”>
<input type=“hidden” name=“lang” value=“en”>
<input type=“submit” value=“Search”>
...</form>
...
</html>
[Formula 4]
<s:Envelope
xmlns:s=“http://schemas.xmlsoap.org/soap/envelope/”>
  <s:Body>
    <html2ws:sessionInfo xmlns:html2ws=“uri:html2ws.xsd”>
<html2ws:action>/order/Submit.jsp;jsessionid=OqXn3Ab9</html2ws:
action>
<html2ws:cookie>ahfodada:adfaxlkjdfa:OqXn3Ab9</html2ws:cookie>
      <html2ws:hidden name=“id”>OqXn3Ab9<html2ws:hidden>
    </html2ws:sessionInfo>
    <m:searchResponseElement xmlns:m=“uri:app.xsd”>
      <m:queryResults>
        <m:queryResult>
          <m:url>http://www.britneyspears.com/</m:url>
          <m:rank>100</m:rank>
        </m:queryResult>
        ...
      </m:queryResults>
    </m:searchResponseElement>
  </s:Body>
</s:Envelope>
```

### <Example of Implementing Web Service>

An example of implementing a single Web service by combining a plurality of Web service ports by using BPEL4WS is shown below, in which the Web service ports are obtained from a simple stateful Web application by utilizing the Web service proxy according to the present invention. FIG. 23 is a screen (page) transition diagram for a target Web application, “Shop.” However, pages unconcerned with the Web service conversion are omitted here, and page transitions unconcerned with the Web service conversion (indicated by dotted lines) are not used in the following description.

This Web application operates as follows.

1) When a user accesses a publicly known URI, a login page (Login) 701 is displayed.
2) On the login page (Login) 701, a user name (Username) 702 and a password (Password) 703 are received from a form. If the login succeeds, a catalog page (Catalog) 704 is displayed.
3) When an item (Item No.) 705 is selected from a list in a form on the catalog page (Catalog) 704, a page (Item) 706 showing information about that item is displayed. However, if the item is out of stock, a page (No Stock) 707 indicating that the item is out of stock is displayed.
4) When a “Buy” button is pressed in a form on the item information page (Item) 706, a page (Shopping Cart) 708 showing a shopping cart carrying the item is displayed.
5) When an “order” button is pressed in a form on the shopping cart page (Shopping Cart) 708, the item on the shopping cart is ordered, and an order information page (Order) 709 is displayed. The order information page (Order) 709 shows information indicating an expected delivery date (Delivery Date) 710.

When the Web service conversion proxy according to the present invention is provided with appropriate setting information (information on an input form necessary for transition to the next page, data to be extracted from the next page and the extraction method, naming on the WSDL, etc.), five Web service ports are implemented corresponding to dotted rectangles (711 to 715) shown in FIG. 24. Operation of each port is indicated at the left of each dotted rectangle.

The following five are the implemented Web service ports corresponding to the above-described Web application operations.

1) start( ): This returns session management information (context) (res0). (Actually, the content of the context is always void.)
2) login( ): This receives session management information (context), a user name (username), and a password (password) (req1) and returns the session management information (context) (res1).
3) showItem( ): This receives the session management information (context) and an item number (item number) (req2) and returns the session management information (context) and whether the item is in stock (is in stock?) (res2). From the transition target page (Item or No Stock), whether it is an out-of-stock page or not is extracted (for example, based on an evaluation result of XPath designation).
4) putItemIntoCart( ): This receives the session management information (context) (req3) and returns the session management information (context) (res3).
5) orderItemsInCart( ): This receives the session management information (context) (req4) and returns the session management information (context) and an expected delivery date (delivery date) (res4). From the transition target page (Order), a portion that indicates the expected delivery date is extracted (for example, based on an evaluation result of XPath designation).

A BPEL4WS program that accesses the resulting five Web service ports to provide a single Web service can be written as follows.

[Formula 5]
1 <process name=“buyItemProcess” ..>
2 ...
3 <sequence>
4 <receive name=“receive” partner=“customer”
portType=“app2:buyItemPT”
5 Operation=“buyItem” variable=“request”/>
6
7 <invoke name=“invokeStart” partner=“adaptationProxy”
8 portType=“app:startPT” operation=“start”
9 outputVariable=“res0”/>
10
11 <assign>
12 <copy>
13 <from variable=“res0” part=“http2ws:SessionInfo”/>
14 <to variable=“req1” part=“http2ws:SessionInfo”/>
15 </copy>
16 <copy>
17 <from variable=“request” part=“app2:username”/>
18 <to variable=“req1” part=“app:username”/>
19 </copy>
20 <copy>
21 <from variable=“request” part=“app2:password”/>
22 <to variable=“req1” part=“app:password”/>
23 </copy>
24 </assign>
25
26 <invoke name=“invokeLogin” partner=“adaptationProxy”
27 portType=“app:loginPT” operation=“login”
28 inputVariable=“req1” outputVariable=“res1”/>
29
30 <assign>
31 <copy>
32 <from variable=“res1” part=“http2ws:SessionInfo”/>
33 <to variable=“req2” part=“http2ws:SessionInfo”/>
34 </copy>
35 <copy>
36 <from variable=“request” part=“app2:itemNumber”/>
37 <to variable=“req2” part=“app:itemNumber”/>
38 </copy>
39 </assign>
40
41 <invoke name=“invokeShowItem” partner=“adaptationProxy”
42 portType=“app:showItemPT” operation=“showItem”
43 inputVariable=“req2” outputVariable=“res2”/>
44 <assign>
45 <copy>
46 <from variable=“res2” part=“http2ws:SessionInfo”/>
47 <to variable=“req3” part=“http2ws:SessionInfo”/>
48 </copy>
49 </assign>
50
[Formula 6]
51 <switch>
52 <case condition=“! bpws:getVariableProperty(res2,
app:isInStock)”>
53 <throw faultName=“app2:outOfStock”/>
54 </case>
55 </switch>
56
57 <invoke name =“invokePutItemIntoCart”
partner=“adaptationProxy”
58 portType=“app:putItemIntoCartPT”
operation=“putItemIntoCart”
59 inputVariable=“req3” outputVariable=“res3”/>
60
61 <assign>
62 <copy>
63 <from variable=“res3” part=“http2ws:SessionInfo”/>
64 <to variable=“req4” part=“http2ws:SessionInfo”/>
65 </copy>
66 </assign>
67
68 <invoke name =“invokeOrderItemsInCart”
partner=“adaptationProxy”
69 portType=“app:orderItemsInCart”
operation=“orderItemsInCart”
70 inputVariable=“req4” outputVariable=“res4”/>
71
72 <assign>
73 <copy>
74 <from variable=“res4” part=“app:deliveryDate”/>
75 <to variable=“response” part=“app2:deliveryDate”/>
76 </copy>
77 </assign>
78
79 <reply name =“reply” partner =“customer”
portType=“app2:buyItemPT”
80 operation=“buyItem” variable=“response”/>
81 </sequence>
82 </process>

The Web service (operation name “buyItem”) implemented by this BPEL4WS program receives an item number (app2:itemNumber), a user name (app2:username), and a password (app2:password) (“request” variable, lines 4-5) and returns an expected delivery date (app2:deliveryDate) (“response” variable, lines 79-80). While detailed description is omitted, those parts that are important to illustrate the applicability of the present invention are described below.

Each “invoke” part (lines 7 to 9, 26 to 28, 41 to 43, 57 to 59, and 68 to 70) accesses a Web service port resulting from the Web service conversion according to the present invention. For example, the first invoke part (lines 7 to 9) sets operation=“start” and invokes the “start” operation. The value returned as a result of invoking the service is stored in the variable res0 by setting outputVariable=“res0”. Designations of other attributes are merely for naming or for indicating descriptions in the WSDL, and therefore need not to be cared for here. Although not used in the first invoke part (lines 7-9), setting inputVariable=“x” could cause a value stored in the variable x to be passed when the service is invoked. Each “assign” part (lines 11 to 24, 30 to 39, 44 to 49, 61 to 66, and 72 to 77) sets data to be passed between the two preceding and following Web service invocations (“invoke” parts) (session management information), and other data to be provided when the following “invoke” part (user name, password, and item number) is accessed. For example, the first “assign” part (lines 11 to 24) operates as follows.

1) Located between the “start” operation (lines 7 to 9) and the “login” operation (lines 26 to 28), it copies (lines 12 to 15) the session information part (http2ws:SessionInfo), from the variable res0 containing the result of the “start,” into a value indicated by the variable req1 to be passed to the “login.”
2) It copies (lines 16 to 23) the user name (app2:username) and the password (app2:password), from the variable “request” having stored a value received by the operation “buyItem” implemented by the program, into the value indicated by the variable “req1” to be passed to the “login” operation (lines 26 to 28).

Thus, with the technique according to the present invention, a stateful Web application converted into a Web service can be accessed without problems simply by using and passing the received session information as is when invoking the next operation. The rest of the processing is similar to typical processing in combining a plurality of Web services and is not particular to the technique according to the present invention. Basically, an application-specific required input may be passed on operation invocation, and an application-specific required output may be received from operation invocation.

Services obtained using the technique according to the present invention may not only be invoked simply sequentially, but one may also be free to change the control flow depending on the operation invocation result of each service, or to use an invocation result other than the session information for the next invocation. For example, at the switch part (lines 51 to 55) below the “invoke ShowItem” invoke and the following “assign” part, a switch syntax is used to check the information about whether or not the item is in stock in the result (res2) obtained by invoking the showItem operation. If the item is out of stock, a SOAP fault is returned as a result of the buyItem invocation (i.e., the Web service implemented by the program).

FIG. 25 is a diagrammatic representation of the same program. The first <receive name> part 801 defines a message to be received by the implemented Web service, while the last <reply name> 802 part defines a message to be returned by the implemented Web service. The <invoke> parts 901 to 905 indicate requests to and responses from the Web service. FIG. 26 shows the same program with additional arrows for indicating data flows. Dotted arrows indicate a flow of the session management information, dashed arrows indicate a flow of data extracted from pages, and chain lines indicate a flow of data used for entering on the forms.

The session management information (http2ws:sessionInfo) is essentially used along with the flow of program control. Although the program control here is linear except for certain branches, there may be loops and branches, and the session management information (http2ws:sessionInfo) will be used along with such flows. In addition, although the flow of data extracted from pages (dotted arrows) and the flow of data used for entering on the forms (chain lines) are independent to each other here, these flows may be connected in some programs (extracted data may be used for entering on the forms).

While the present invention has been described above using embodiments and examples, the technical scope of the present invention is not limited to the scope described in the above embodiments. Rather, various modifications and improvements may be made to the above embodiments. It is apparent from the claims that such modified or improved embodiments may also be included in the technical scope of the present invention.

In one embodiment, the present invention may be implemented mainly by a computer program residing on a proxy apparatus or proxy server. A storage medium for storing the program may be a hard disk; a magnetic recording medium such as a floppy (R) disk; an optical recording medium such as a CD-ROM, DVD, or PD; a magneto-optical recording medium such as an MD; a tape medium; semiconductor memory such as an IC card, and so on. Furthermore, the program may be provided to a computer system via a memory device, such as a hard disk or RAM, included in a server system connected to a network.

### BRIEF DESCRIPTION OF THE DRAWINGS

FIG. 1 shows a system configuration diagram according to the present invention;

FIG. 2 shows transmission and reception between a stateless Web application and a user;

FIG. 3 shows a Web service conversion of a conventional stateless Web application;

FIG. 4 shows a Web service conversion according to the present invention;

FIG. 5 shows a transmission and reception process for session management information between two Web services using the Web service conversion;

FIG. 6 shows exemplary messages having HTTP message structures;

FIG. 7 shows SOAP message structures (left: by a conventional technique, right: by a technique according to the present invention);

FIG. 8 shows a structure of a session information section according to the present invention;

FIG. 9 shows an overview of a Web service conversion algorithm according to the present invention;

FIG. 10 shows an algorithm for generating an HTTP request;

FIG. 11 shows an algorithm (1) for processing user session information for a request;

FIG. 12 shows an algorithm (2) for processing user session information for a request;

FIG. 13 shows an algorithm (3) for processing user session information for a request;

FIG. 14 shows an algorithm (1) for processing user session information for a response;

FIG. 15 shows an algorithm (2) for processing user session information for a response;

FIG. 16 shows an algorithm (3) for processing user session information for a response;

FIG. 17 shows setting information provided to a Web service conversion proxy of the technique according to the present invention;

FIG. 18 shows a WSDL Generator;

FIG. 19 shows a WSDL generation algorithm;

FIG. 20 shows exemplary settings for the conversion proxy;

FIG. 21 shows an exemplary WSDL automatically generated from given settings;

FIG. 22 shows exemplary messages for a “search” operation;

FIG. 23 shows a screen transition diagram for an exemplary simple Web application “Shop;”

FIG. 24 shows five Web service ports implemented by applying the technique according to the present invention to the Web application “Shop;”

FIG. 25 shows an exemplary BPEL4WS program list on a Web service client; and

FIG. 26 shows data flows in the exemplary BPEL4WS program list.

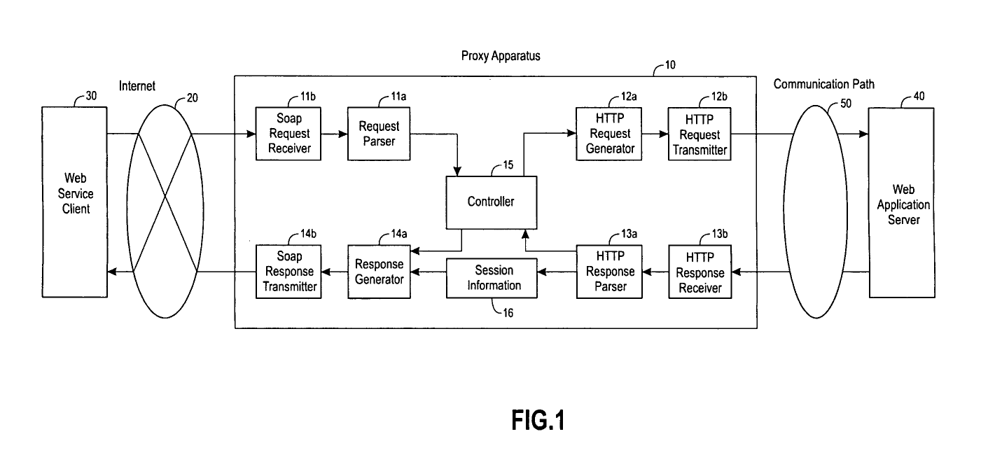

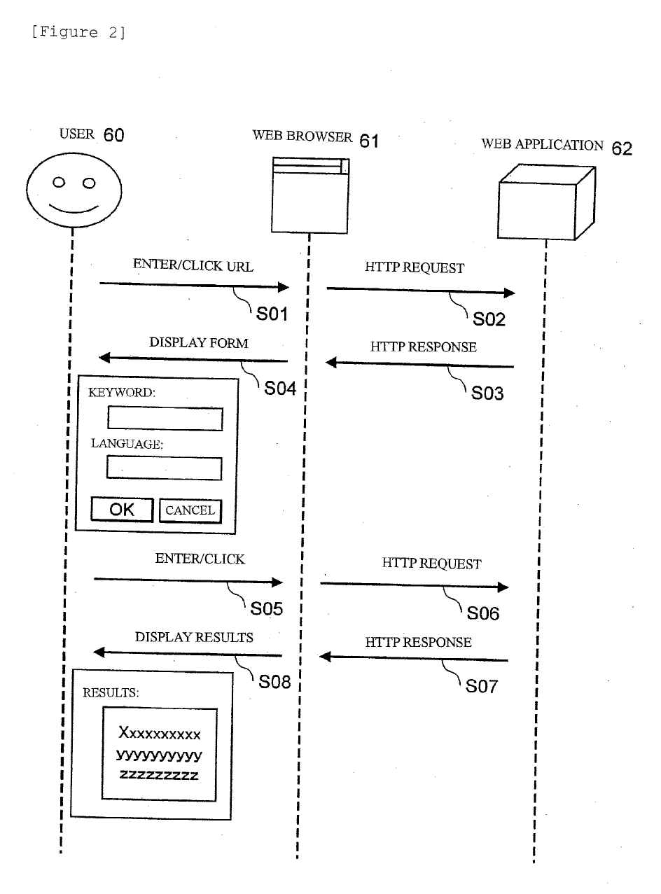

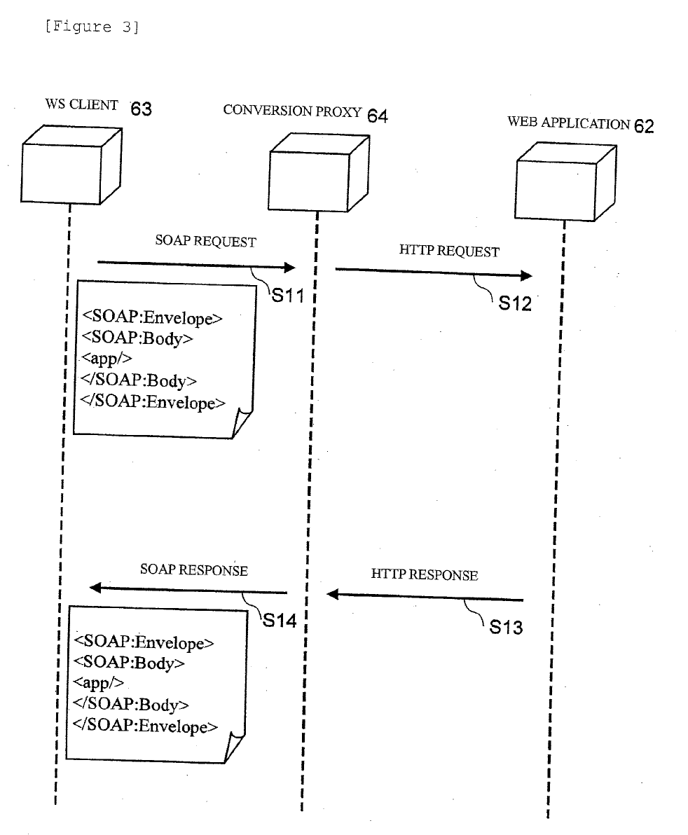

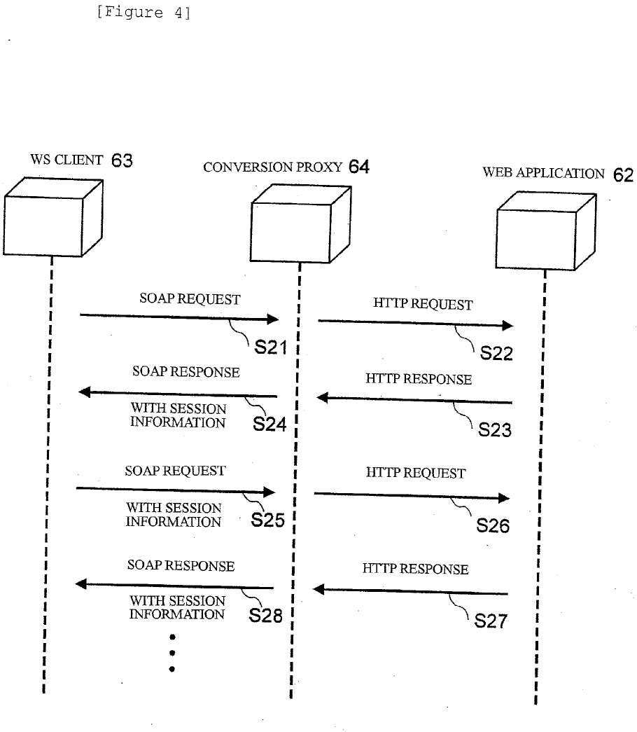

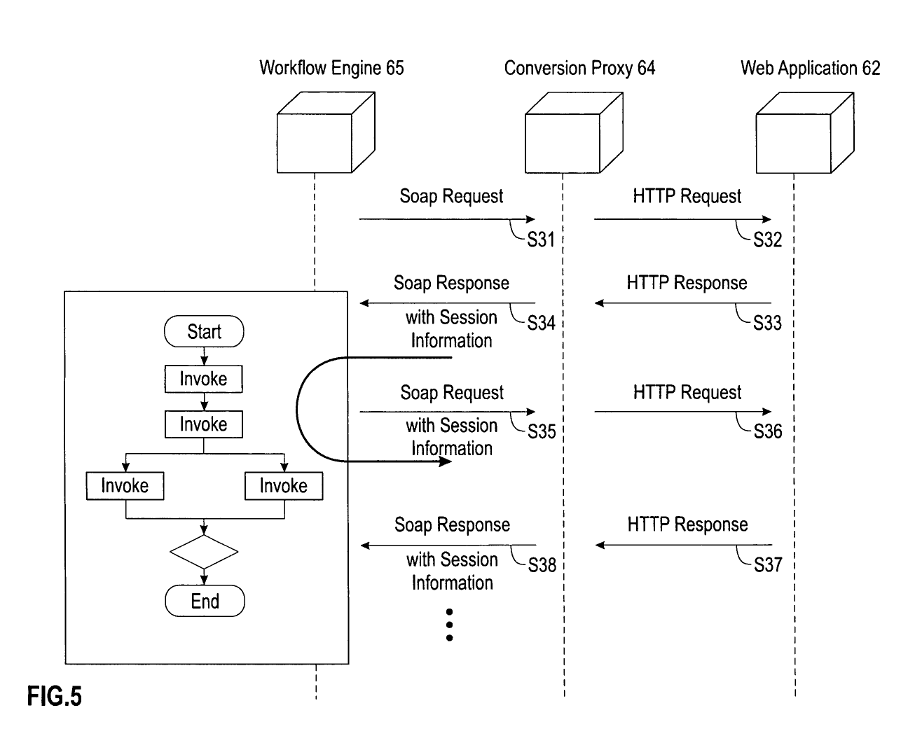

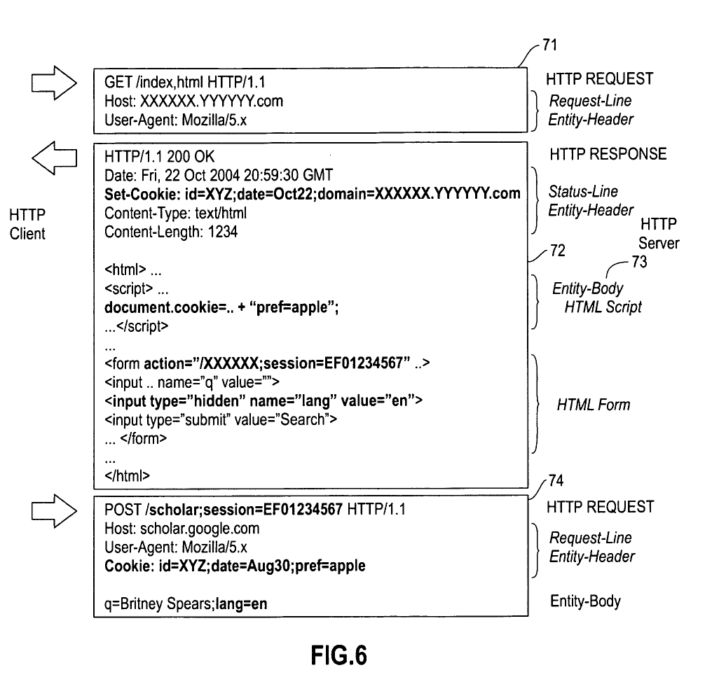

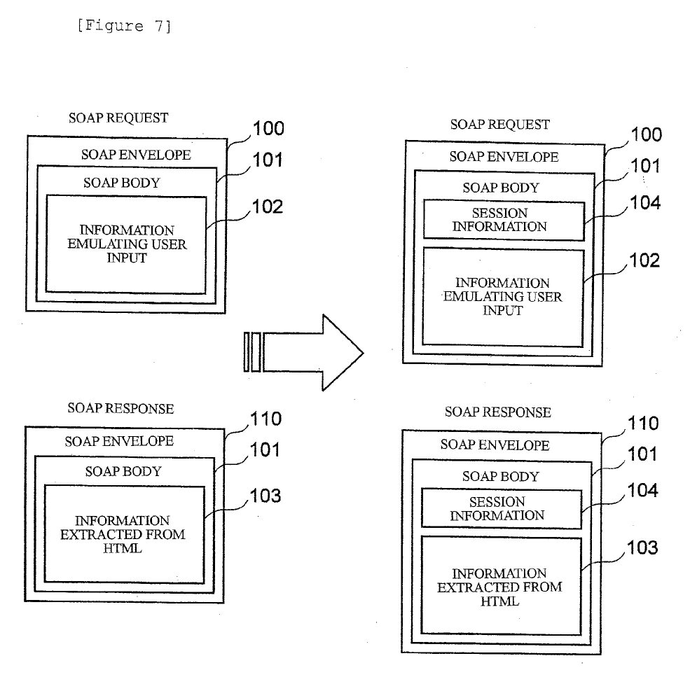

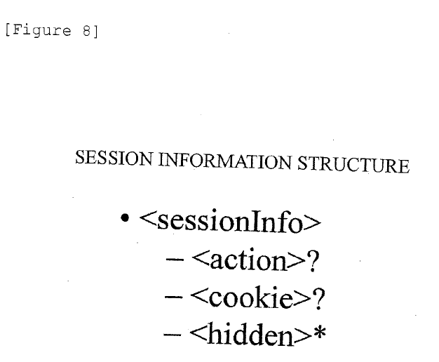

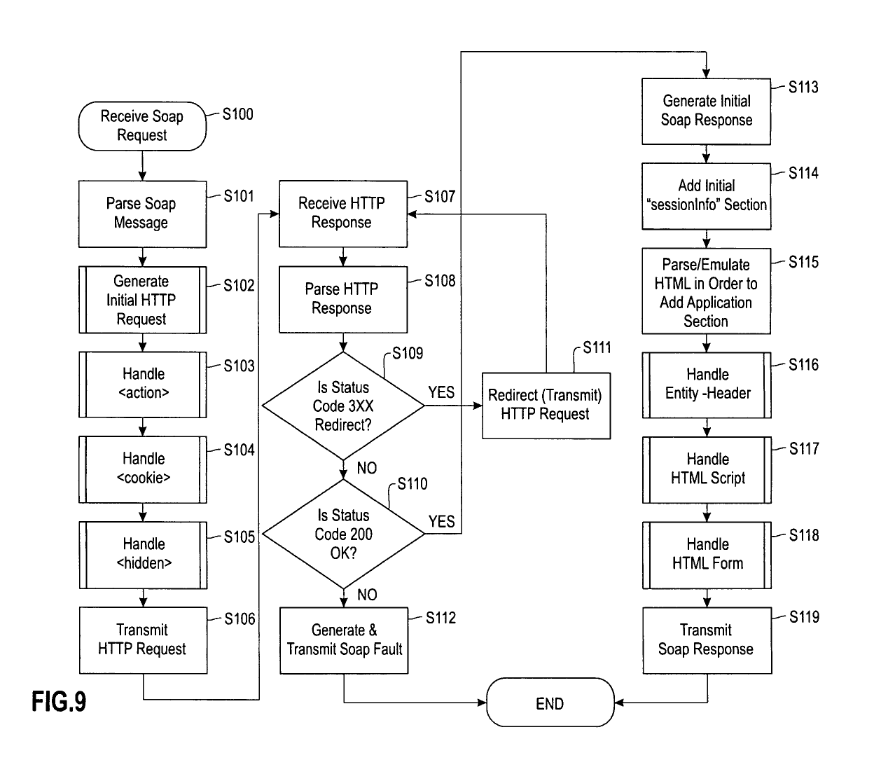

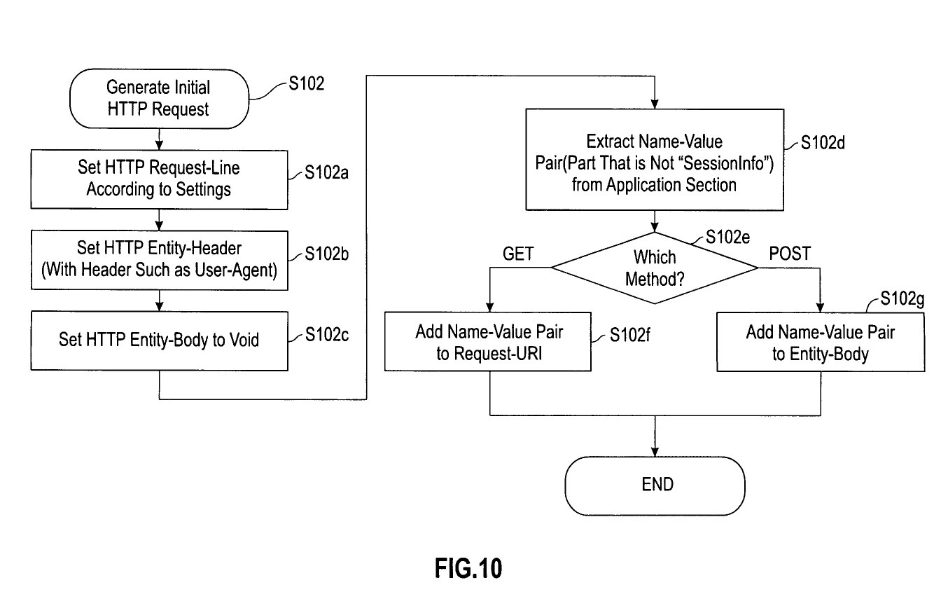

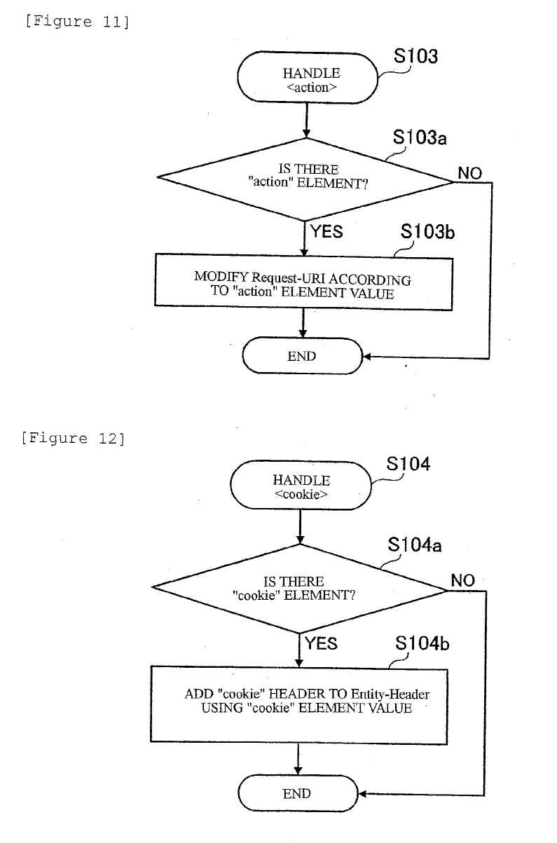

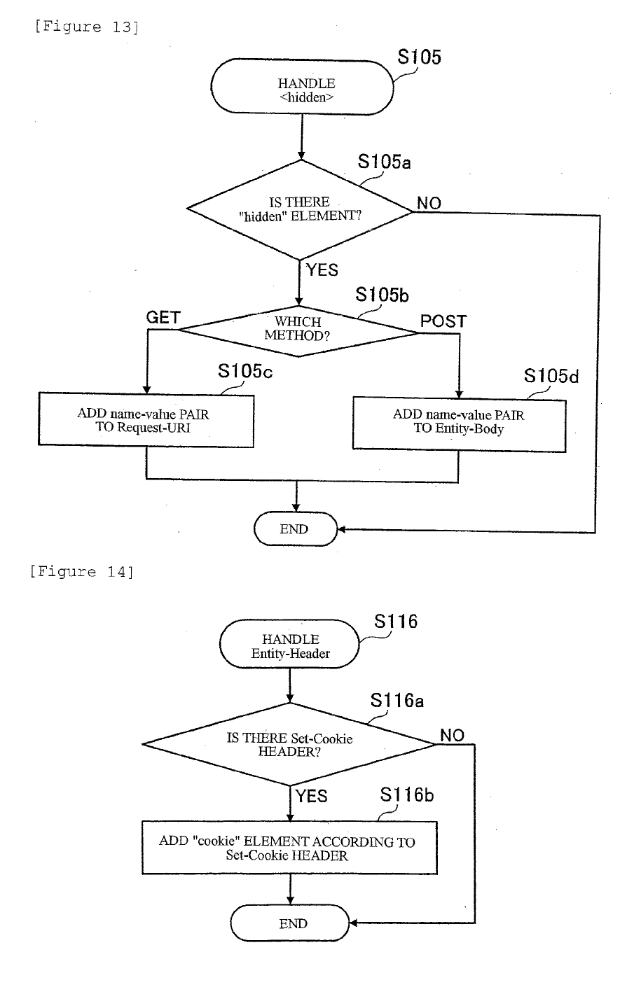

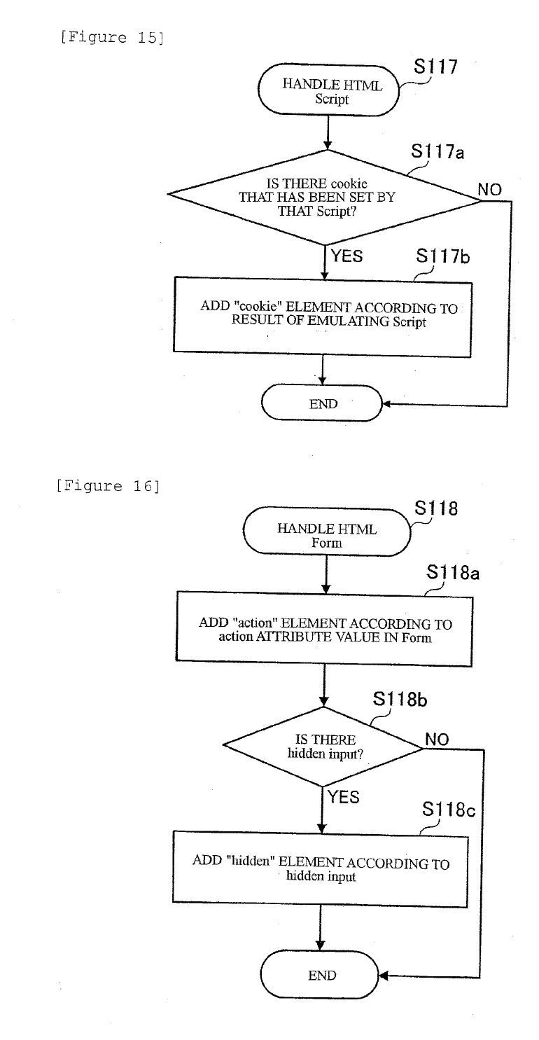

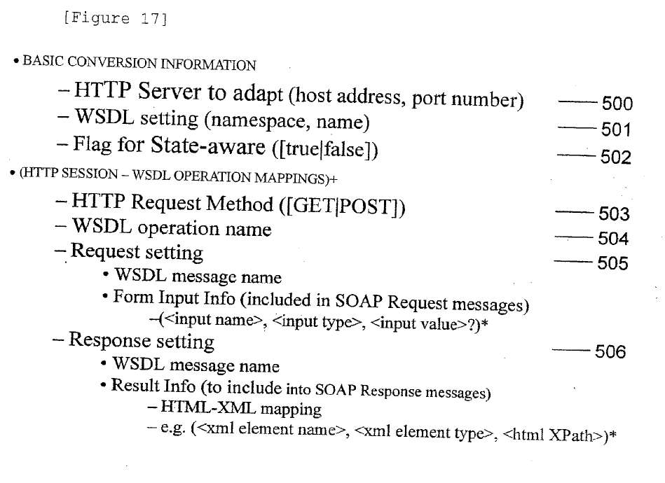

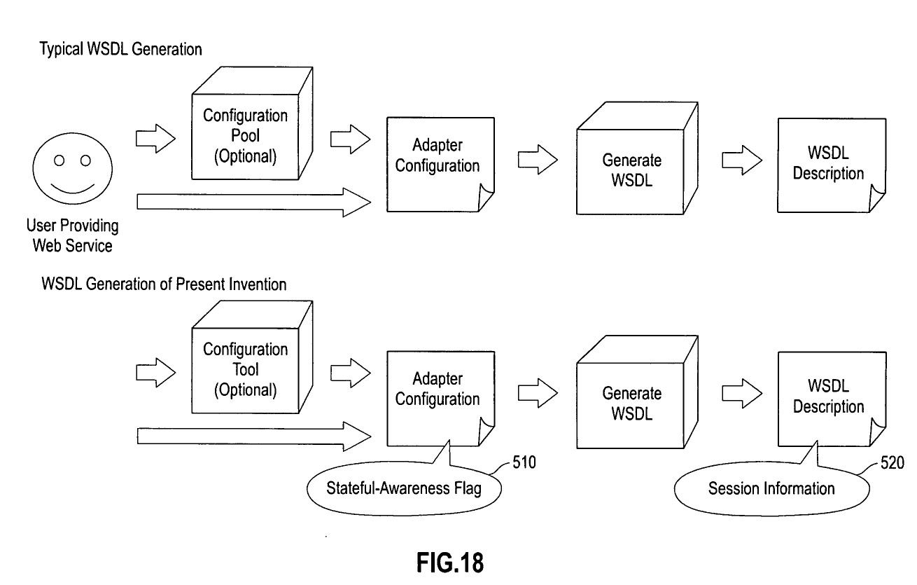

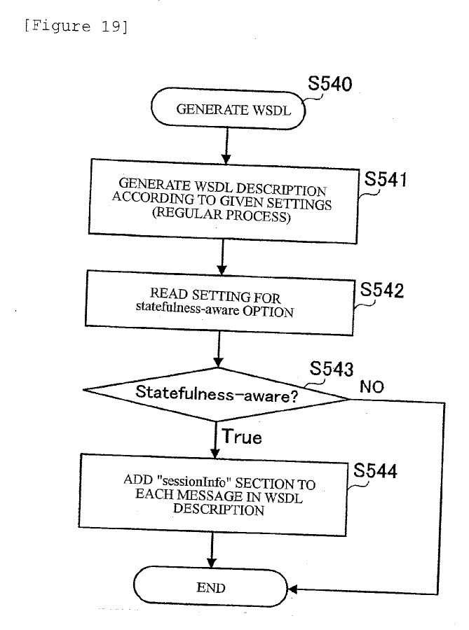

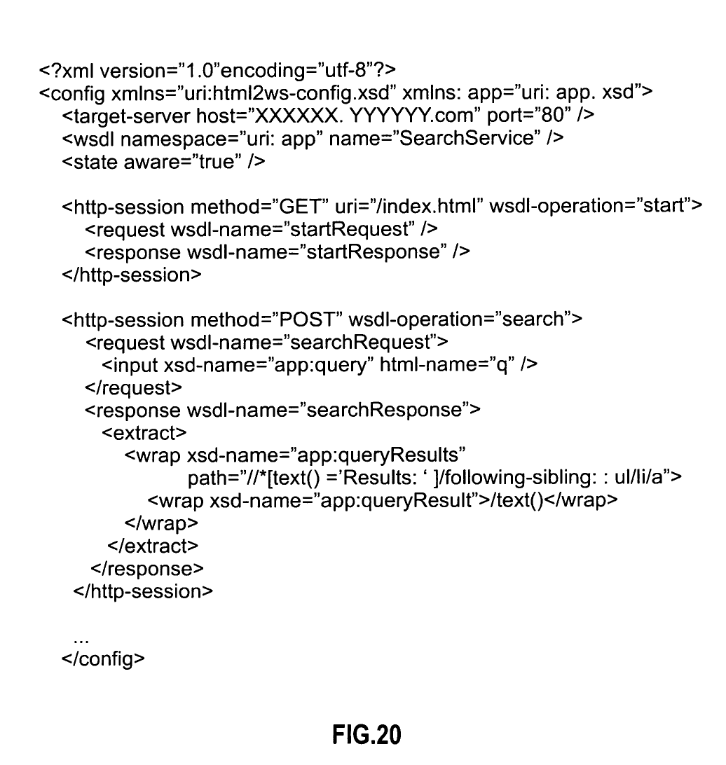

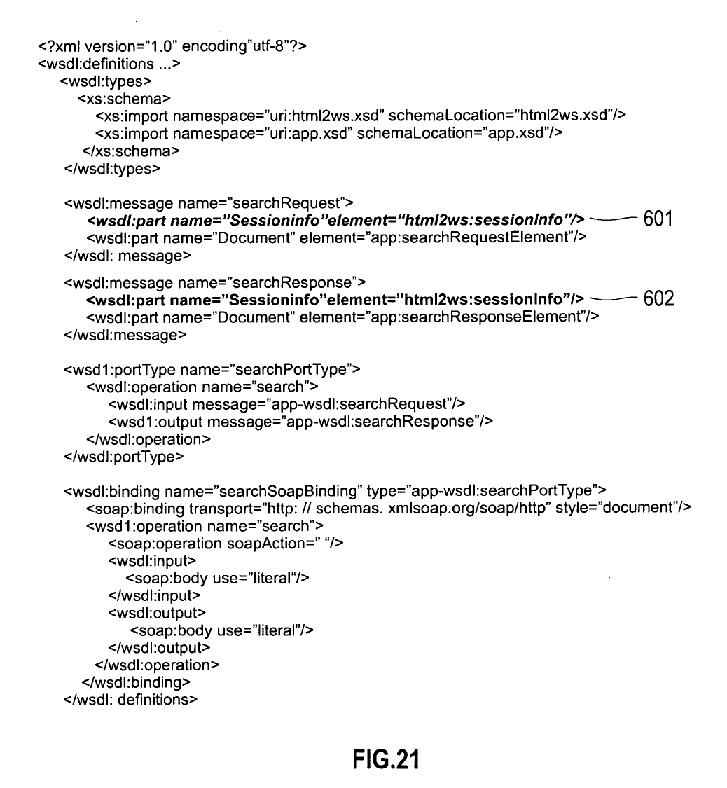

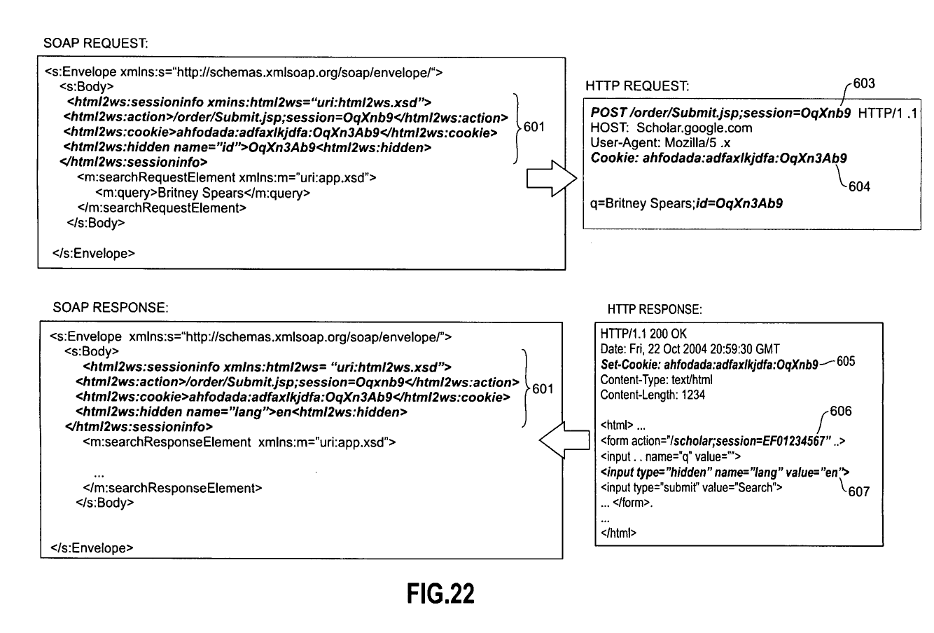

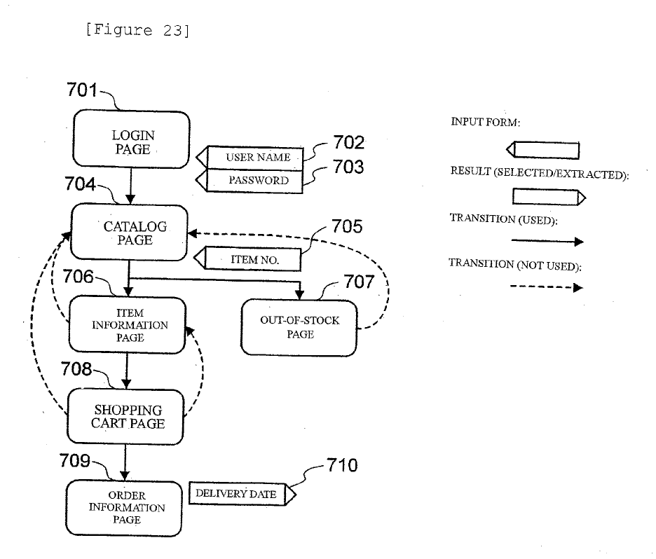

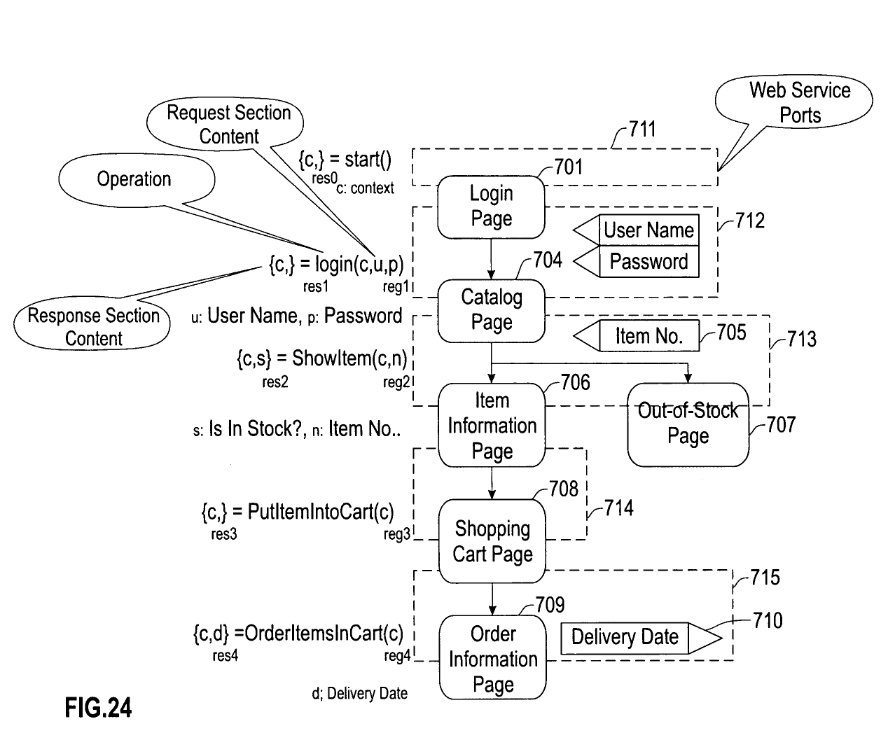

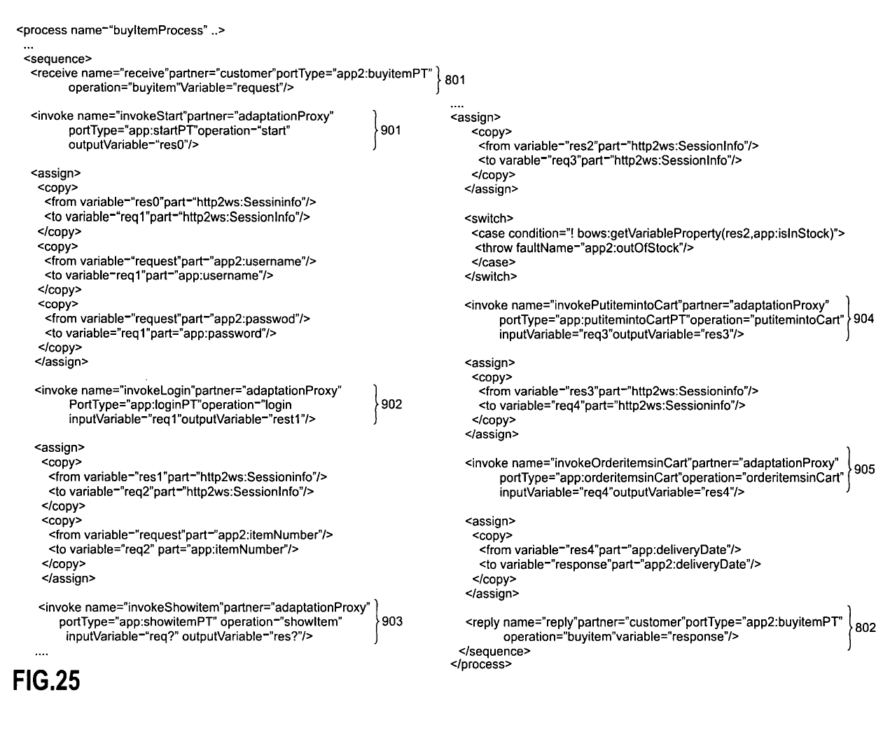

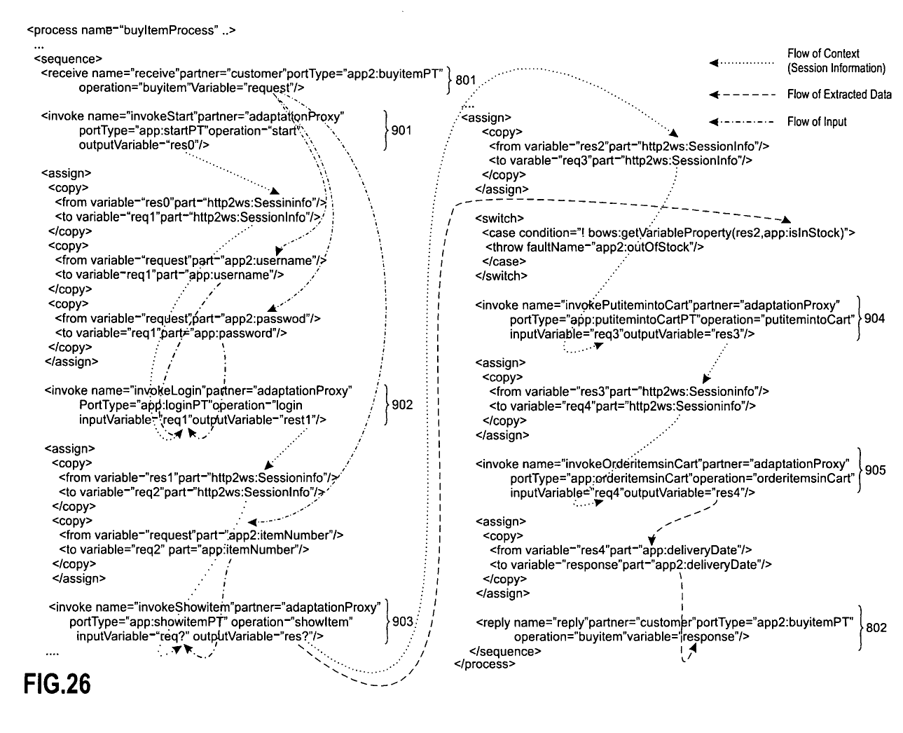

### DESCRIPTION OF SYMBOLS

10 . . . proxy apparatus
11a . . . request parser
11b . . . SOAP request receiver
12a . . . HTTP request generator
12b . . . HTTP request transmitter
13a . . . HTTP response parser
13b . . . HTTP response receiver
14a . . . response generator
14b . . . SOAP response transmitter
15 . . . controller
20 . . . . Internet
30 . . . . Web service client
40 . . . . Web application server
50 . . . communication path
60 . . . user
61 . . . . Web browser
62 . . . . Web application
63 . . . WS client
64 . . . conversion proxy
100 . . . SOAP request
101 . . . SOAP envelope
102 . . . information emulating user input
103 . . . information extracted from HTML
104 . . . session information
701 . . . login page
704 . . . catalog page
706 . . . item information page
707 . . . out-of-stock page
708 . . . shopping cart page
709 . . . order information page

1) A method for providing a Web service in which a proxy apparatus accesses a Web application server in response to a request from a Web service client, the method comprising the steps of:
transmitting an HTTP request to the application server in response to a request from the Web service client;
embedding, into a response to the Web service client, user session information extracted from an entity header and an entity body in an HTTP response returned from the Web application server, in addition to application information extracted from the entity body in the HTTP response; and
embedding the user session information contained in a request from the Web service client into an entity header and an entity body as part of application data in an HTTP request and transmitting the HTTP request to the Web application server.

2) The method for providing a Web service according to claim 1, wherein the request from the Web service client is a SOAP request, and the response to the request is a SOAP response.

3) The method for providing a Web service according to claim 1, wherein the user session information is URI information, Set-Cookie header information, and hidden tag information.

4) The method for providing a Web service according to claim 3, comprising the step of generating a WSDL by the proxy apparatus as Web service interface information based on configuration information provided in advance from a user.

5) The method for providing a Web service according to claim 4, wherein the configuration information contains information indicating to the proxy apparatus whether a Web application includes a plurality of sessions or not.

6) The method for providing a Web service according to claim 4, wherein a description is added to the WSDL, said description directing that the user session information embedded into the HTTP request be embedded into the SOAP request as part thereof.

7) The method for providing a Web service according to claim 4, wherein a description is added to the WSDL, said description directing that the user session information in the HTTP response be embedded into the SOAP response as part thereof.

8) A proxy apparatus that provides a Web service by accessing a Web application server in response to a request from a Web service client, the proxy apparatus comprising:
a response generator that embeds, into a response to the Web service client, user session information extracted from an entity header and an entity body in an HTTP response returned from the Web application server, in addition to application information extracted from the entity body in the HTTP response;
an HTTP request generator that embeds the user session information contained in a request from the Web service client into an entity header and an entity body as part of application data in an HTTP request; and
an HTTP request transmitter that transmits the HTTP request generated by the HTTP request generator to the Web application server in response to a request from the Web service client.

9) The proxy apparatus according to claim 8, wherein the request from the Web service client is a SOAP request, and the response to the request is a SOAP response.

10) The proxy apparatus according to claim 8, wherein the user session information is URI information, Set-Cookie header information, and hidden tag information.

11) A computer program product for providing a Web service by accessing a Web application server in response to a request from a Web service client, the computer program product causing a computer to perform the steps of:
transmitting an HTTP request to the application server in response to a request from the Web service client;
embedding, into a response to the Web service client, user session information extracted from an entity header and an entity body in an HTTP response returned from the Web application server, in addition to application information extracted from the entity body in the HTTP response; and
embedding the user session information contained in a request from the Web service client into an entity header and an entity body as part of application data in an HTTP request and transmitting the HTTP request to the Web application server.

12) The computer program product according to claim 11, wherein the request from the Web service client is a SOAP request, and the response to the request is a SOAP response.

13) The computer program product according to claim 11, wherein the user session information is URI information, Set-Cookie header information, and hidden tag information.
